(19) United States
(12) Patent Application Publication
(10) Pub. No.: US 2010/0091259 A1
(43) Pub. Date: Apr. 15, 2010

(54) EXPOSURE APPARATUS

(75) Inventor: Ryo Koizumi, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/579,085

(22) Filed: Oct. 14, 2009

(30) Foreign Application Priority Data
Oct. 14, 2008 (JP) 2008-264902

(51) Int. Cl. G03B 27/54

(52) U.S. Cl. 355/67

(57) ABSTRACT

An exposure apparatus is configured to expose a substrate via a liquid filled in a space between the substrate and a final optical element in a projection optical system which is closest to the substrate. The exposure apparatus includes a pressure detector configured to detect a pressure of the liquid, a holder configured to hold the final optical element, a movement unit configured to move the holder, and a controller configured to control the movement unit and move the holder based on a detection result of the pressure detector so as to reduce an aberration of the projection optical system.

### BACKGROUND OF THE INVENTION

1. Field of the Invention

The present invention relates to an exposure apparatus.

2. Description of the Related Art

In some immersion exposure apparatuses configured to expose a substrate via a liquid, a final lens in a projection optical system which is closest to the substrate cannot be perfectly fixed so as to make a barrel of the projection optical system small or to avoid interference with a liquid supply and recovery mechanism. As a result, as the pressure of the liquid fluctuates, a position of the final lens changes and an imaging characteristic deteriorates.

Accordingly, Japanese Patent Laid-Open No. (“JP”) 2007-318137 proposes an adjustment of the pressure in a space between the final lens and another lens above the final lens when the pressure of the liquid fluctuates.

JP 2007-318137 can adjust the final lens by adjusting the pressure in the space between the final lens and the other lens above it, but causes a new deterioration of the imaging characteristic because the adjustment also moves the other lens above the final lens.

### SUMMARY OF THE INVENTION

The present invention proposes an immersion exposure apparatus configured to maintain an imaging characteristic.

An exposure apparatus according to one aspect of the present invention is configured to expose a substrate via a liquid filled in a space between the substrate and a final optical element in a projection optical system which is closest to the substrate. The exposure apparatus includes a pressure detector configured to detect a pressure of the liquid, a holder configured to hold the final optical element, a movement unit configured to move the holder, and a controller configured to control the movement unit and move the holder based on a detection result of the pressure detector so as to reduce an aberration of the projection optical system.

Further features of the present invention will become apparent from the following description of exemplary embodiments with reference to the attached drawings.

### BRIEF DESCRIPTION OF THE DRAWINGS

FIG. 1 is a block diagram of an exposure apparatus according to this embodiment.

FIG. 2 is a partially enlarged sectional view of a structure when a pressure detector is used.

FIG. 3 is a schematic plane view showing an illustrative arrangement of the pressure detector shown in FIG. 2.

FIG. 4 is a partially enlarged sectional view of a structure when the position detector is used.

### DESCRIPTION OF THE EMBODIMENTS

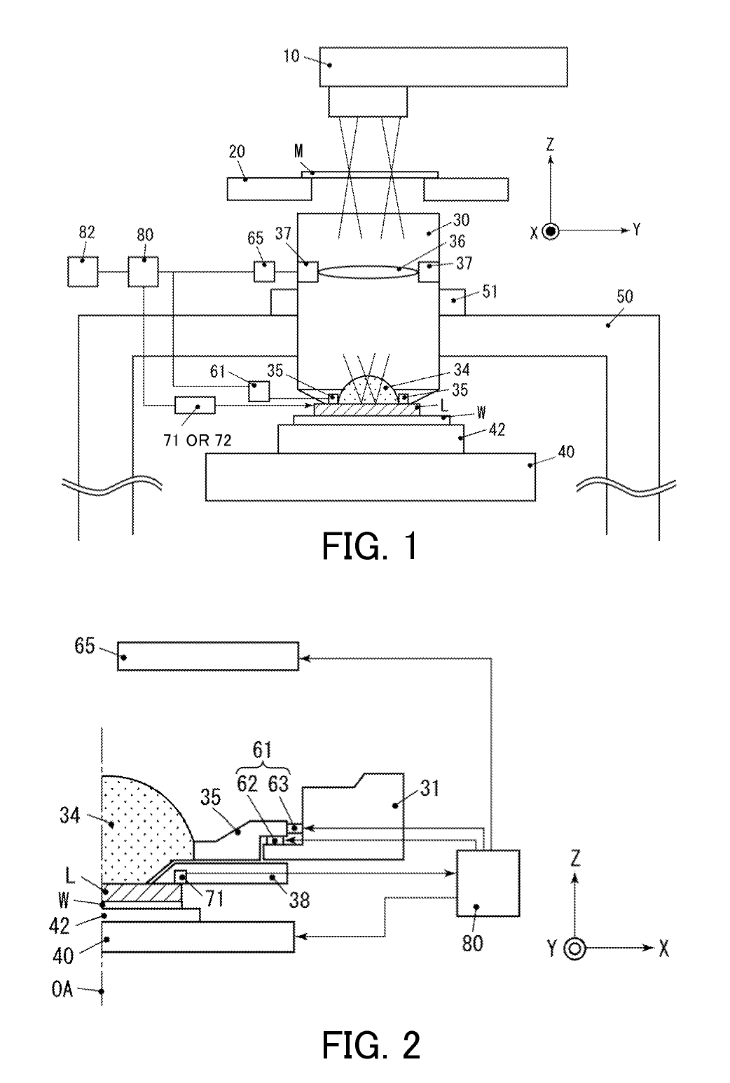

FIG. 1 is a block diagram of an exposure apparatus. The exposure apparatus of this embodiment is a step-and-scan type exposure apparatus but the present invention is applicable to a step-and-repeat type exposure apparatus. Since the pressure of the liquid L is likely to fluctuate in the scan exposure, the present invention is particularly effective for the scanning exposure apparatus.

The exposure apparatus includes an illumination unit 10, an original stage 20, a projection optical system 30, a substrate stage 40, a substrate chuck 42, a movement unit, a detector, and a controller. The exposure apparatus is a projection exposure apparatus configured to expose an image of a pattern of an original M onto a substrate W via the projection optical system 30 by utilizing a light beam from a light source. In addition, the exposure apparatus is an immersion exposure apparatus configured to expose the substrate W via the liquid having a refractive index larger than that of air.

The illumination unit 10 illuminates the original M, and includes a light source that emits a light beam as exposure light, and an illumination optical system configured to uniformly illuminate the original.

The original M is an original (mask or reticle) having a circuit pattern to be exposed.

The original stage 20 supports the original M. The original stage 20 is provided with a drive mechanism (not shown) configured to drive the original stage 20 in a Y direction as a scan direction. An X direction is a direction orthogonal to the scan direction. The Z direction is a perpendicular to the XY plane, and parallel to an optical axis direction of the projection optical system 30.

The projection optical system 30 maintains an optically conjugate relationship between the original M and the substrate W, and projects an image of the pattern of the original M onto the substrate W. The projection optical system 30 has a barrel 31 that is fixed onto a frame 50 via a fixture means 51. The frame 50 is a rigid member placed on a floor via a damper (not shown).

The projection optical system 30 includes a plurality of optical elements, which includes a final optical element (final lens) 34 closest to the substrate W, and an optical element 36 other than the final optical element 34. The final optical element 34 may be a conventional distortion correcting optical element or another optical element that is added with it or a new optical element. For illustration purposes, FIG. 1 shows the optical element 36 as one lens but the optical element 36 actually includes a plurality of optical elements.

FIG. 2 is a sectional view near the final optical element 34, where OA is an optical axis of the projection optical system 30. The final optical system 34 is attached to the barrel 31 of the projection optical system 30. One second holder 37 is attached to each optical element 36.

The liquid L is filled in a space between the final optical element 34 and the substrate W. The liquid L is recovered and supplied by a nozzle 38 of a liquid supply and recovery mechanism. While this embodiment adopts a local fill method that locally fills the liquid L, the present invention does not limit the filling method of the liquid L. Since the liquid L has a refractive index higher than that of air, the exposure resolution becomes higher than that with air.

When the original M and the substrate W are synchronously scanned, the final optical element 34 is influenced by the pressure of the liquid L. In addition, the pressure of the liquid L changes due to the influence of the exposure light during the exposure. Since it is difficult to provide a mechanism that perfectly fixes the final optical element 34 to the barrel 31 of the projection optical system 30, the final optical element 34 finely displaces due to the disturbance, causing the imaging characteristic to deteriorate.

The substrate stage 40 supports the substrate W, such as a wafer and a liquid crystal display, and drives it in a direction of each of the XYZ axes and a direction around each axis. The substrate W is absorbed and fixed on the substrate stage 40 via the substrate chuck 42.

The movement unit includes a first movement unit 61 configured to move a first holder 35, and a second movement unit 65 configured to move a second holder 37.

The first movement unit 61 includes, as shown in FIG. 2, a first movement element 62 that moves in the Z direction, and a second movement element 63 that moves in the YX directions. The first movement element 62 and the second movement element 63 are fixed onto the barrel 31 of the projection optical system 30 at their one ends and onto the first holder 35 at their other ends, and include a stretchable member, such as a piezoelectric element. Therefore, the first movement part 61 can move the first holder 35 in one or more directions of the XYZ directions.

FIG. 2 shows the first movement element 62 and the second movement element 63 one by one, but three or more first movement elements 62 arranged at 120° intervals will be able to provide three-axis control over the Z driving, an inclination around the X axis as a rotation axis (referred to as a “ωX direction” hereinafter), and an inclination around the Y axis as a rotation axis (referred to as a “ωY direction” hereinafter). A plurality of second movement elements 63 arranged at predetermined positions will provide decentering driving in the XY directions. A combination between the first movement element 62 and the second movement element 63 will provide control over the maximum number of axes of five axes.

The first movement unit 61 can move only the final optical element 34 so as to move the first holder 35 that holds the final optical element 34. Since the first movement unit 61 does not move the optical element that is located higher than the final optical element 34, a new deterioration of the imaging characteristic does not occur unlike JP 2007-318137.

The second movement unit 65 has a structure similar to that of the first movement unit 61. Since the second movement unit 65 can move only the final optical element 36 so as to move the second holder 37 that holds the optical element 36, a new deterioration of the imaging characteristic does not occur unlike JP 2007-318137.

The detector includes a pressure detector 71 configured to detect a pressure of the liquid L or a position detector 72 configured to detect a position of the final optical element 34. The pressure detector 71 indirectly detects a change of a position of the final optical element 34. The position detector 72 directly detects a change of the position of the final optical element 34.

FIG. 2 is a block diagram showing an illustrative structure when the detector is the pressure detector 71. The pressure detector 71 includes a sensor (pressure gauge) configured to monitor the pressure or pressure fluctuation of the liquid L, and to measure the pressure of pressure variation amount during the exposure. While FIG. 2 shows only one pressure detector 71, a plurality of pressure detectors 71 may be arranged so as to detect the pressure distribution.

FIG. 4 is a block diagram showing an illustrative structure when the detector is the position detector 72. The position detector 72 includes a monitor 73 provided to the barrel 31 of the projection optical system 30, and a target mirror 74 provided to the first holder 35. The monitor 73, such as a laser interferometer, can detect a position of the final optical element 34 by detecting the light that has been emitted to the target mirror 74 and reflected from the target mirror 74.

In FIG. 4, the monitor 73 detects a displacement of the target mirror 74 in the Z direction, but may measure the displacements in the X and Y directions by reflecting the light to the target mirror 74 in the X and Y directions and capturing the reflected light. In addition, while FIG. 4 illustrates one pair of monitor 73 and target mirror 74, multiple pairs will be able to detect positional fluctuations with respect to the maximum number of axes of five axes.

The controller 80 controls the first movement unit 61 or the second movement unit 65 based on the detection result of the detector so as to reduce the aberration of the projection optical system 30, and moves the optical element in the projection optical system, such as the final optical element 34 or the optical element 36, dynamically or on the real-time basis. The controller 80 is connected to the memory 82.

The control by the controller 80 of this embodiment is classified into four types based on a type of the detector to be used, i.e., the pressure detector 71 or the position detector 72, and a type of the movement unit to be used, i.e., the first movement unit 61 or the second movement unit 65.

Initially, a description will be given of use of the first movement unit 61 and the pressure detector 71. As the pressure of the liquid L fluctuates, the position of the final optical element 34 fluctuates. In this case, the memory 82 holds, as a table, the following relationship between the pressure variation amount and the position variation amount of the final optical element 34.

Initially, the relationships between measurement values of k pressure detectors 71 and position variation amount of the final optical element 34 will be defined as follows, where ΔGz, ΔGx, ΔGy, ΔGωK, and ΔGωY are displacement amounts of the final optical element 34 in the Z direction, the X direction, the Y direction, the ωX direction, and the ωY direction. ΔF is a displacement amount of the substrate stage 40, and ΔPL is a pressure variation amount at the L-th measurement position of a plurality of pressure detectors 71:

ΔGz=f₁(ΔP1, ΔP2 . . . ΔPL) Equation 1

ΔGx=f₂(ΔP1, ΔP2 . . . ΔPL) Equation 2

ΔGy=f₃(ΔP1, ΔP2 . . . PL) Equation 3

ΔGωx=f₄(ΔP1, ΔP2 . . . PL) Equation 4

ΔGωy=f₆(ΔP1, ΔP2 . . . PL) Equation 5

ΔF=f₆(ΔP1, ΔP2 . . . PL) Equation 6

ΔGz to ΔGωy are expressed by functions of the pressure variation amounts ΔP1 to ΔPL. The distribution of the pressure fluctuation is not necessarily uniform on a plane contact the liquid L due to the disturbance, and the positional change caused by the pressure can fluctuate in the decentering direction as well as a direction other than the Z direction. The functions f₁ to f₆ may be obtained by any methods such as a simulation or an experiment.

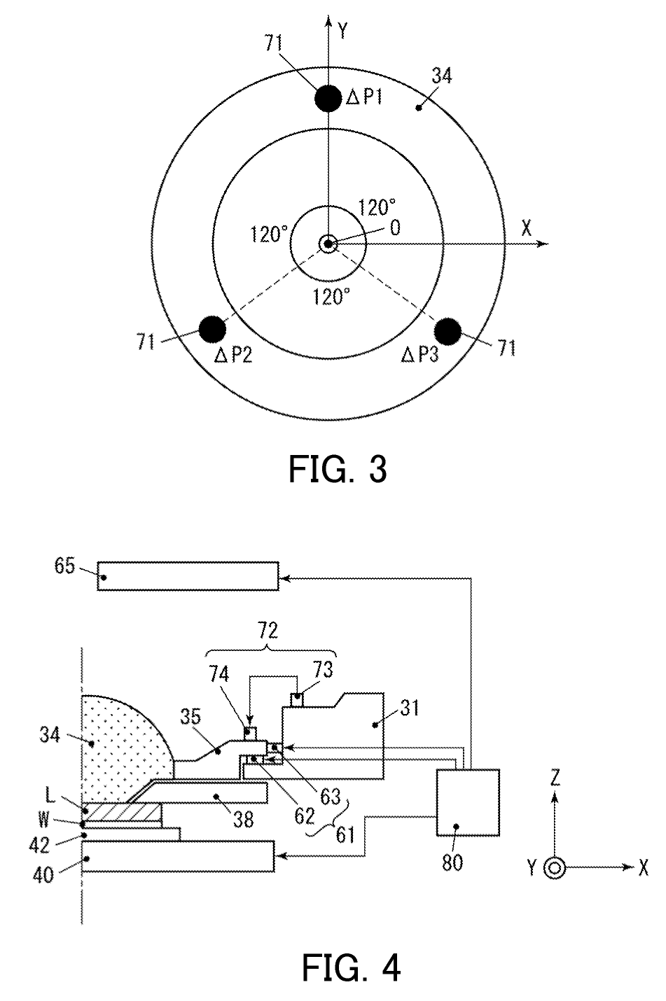

FIG. 3 is a schematic plane view when three pressure detectors 71 are provided around the center O of the final optical element 34 at regular intervals (or 120° intervals), and ΔP1, ΔP2, ΔP3 are hydraulic variation amounts measured by the pressure detector 71. Here, assume that αz, αx, αy, αωx, αωy are proportional coefficients and are variation amounts of the final optical element 34 per unit average pressure fluctuation in the Z direction, the X direction, the Y direction, the ωx direction, and the ωy direction. Then, Equations 1-5 can be expressed as follows:

ΔGz=αz×(ΔP1+ΔP2+ΔP3)/3 Equation 7

ΔGx=αx×(ΔP2−ΔP3) Equation 8

ΔGy=αy×(ΔP1(ΔP2+ΔP3)/2) Equation 9

ΔGωx=αωx×(ΔP1−(ΔP2+ΔP3)/2) Equation 10

ΔGωy=αωy×(ΔP2−ΔP3) Equation 11

The controller 80 obtains a pressure variation amount of the liquid L based on a detection result of the pressure detector 71, and obtains a position variation amount of the final optical element 34 based on the table stored in the memory 82. In order to cancel it, the controller 80 controls the first movement unit 61 and moves the final optical element 34 in a direction reverse to the fluctuation direction by the fluctuation amount.

In this case, this embodiment is different from JP 2007-318137 in that the first movement unit 61 moves only the final optical element 34 and does not move the optical element(s) higher than the final optical element 34. In other words, JP 2007-318137 moves the optical element(s) higher than the final optical element in moving the final optical element and causes a new deterioration of an imaging characteristic, whereas this embodiment does not cause such deterioration.

A description will be given of use of the second movement unit 65 and the pressure detector 71. In this case, the memory 82 holds the table showing the relationship between the pressure variation amount of the liquid L and the variation amount of the final optical element 34. The controller 80 obtains the pressure variation amount of the liquid L based on the detection result of the pressure detector 71, and obtains a movement amount of the final optical element 34 based on the table in the memory 82. Next, the controller 80 operates the aberration variation amount of the projection optical system 30 that is generated as a result of that the final optical element 34 moves. When the final optical element 34 is moved, it may be moved to the original state by the variation amount and it is unnecessary to operate the aberration variation amount. On the other hand, the operation of the aberration variation amount is necessary when another optical element 36 is to be moved.

An aberration variation amount ΔWAi can be operated as follows by using the predicted values of the Equations 1-6:

ΔWAi=SGzi×ΔAGz+SGxi×ΔGx+SGyi×ΔGy+SGωxi×ΔGωx+SGωyi×ΔGωy+SFzi×ΔF Equation 12

SGzi is an aberration sensitivity at the image point i, which is generated when the final optical element 34 is moved in the Z direction by a unit amount. SGxi is an aberration sensitivity at the image point i, which is generated when the final optical element 34 is moved in the X direction by a unit amount. SGyi is an aberration sensitivity at the image point i, which is generated when the final optical element 34 is moved in the Y direction by a unit amount. SGωxi is an aberration sensitivity at the image point i, which is generated when the final optical element 34 is moved in the ωX direction by a unit amount. SGωyi is an aberration sensitivity at the image point i, which is generated when the final optical element 34 is moved in the ωY direction by a unit amount. SFzi is an aberration sensitivity at the image point i, which is generated when the substrate stage 40 is moved in the Z direction by a unit amount.

Since the aberration variation amount ΔWAi calculated by the Equation 12 can be regarded as a certain Zernike coefficient when the wavefront aberration is fitted by the Zernike polynomial, there are a plurality of equations used to express the aberrational amount similar to the Equation 12 by the number of Zernike terms for evaluations.

Assume that the projection optical system 30 has N drive elements, and SG(n)zi, SG(n)xi, SG(n)yi, SG(n)ωxi, and SG(n)ωyi are defined as aberration sensitivities at the image point i, respectively, when the optical element corresponding to the n-th drive element is moved by a unit amount. In that case, the following equation expresses an addition between the aberration variation amount ΔWAi caused by the position variation amount of the final optical element 34 and the aberration variation amount when the optical element 36 is driven:

$$Δ WAi + {\sum }_{n = 1}^{N} SG ( n ) zi \times Δ G ( n ) z + {\sum }_{n = 1}^{N} SG ( n ) xi \times Δ G ( n ) x + {\sum }_{n = 1}^{N} SG ( n ) yi \times Δ G ( n ) y + {\sum }_{n = 1}^{N} SG ( n ) ω xi \times Δ G ( n ) ω x + {\sum }_{n = 1}^{N} SG ( n ) ω yi \times Δ G ( n ) ω y + {\sum }_{k = 1}^{M} S ( k ) i \times Δ T ( k ) \qquad Equation 13$$

The Equation 13 provides a value corresponding to a certain Zernike term, and there are actually a plurality of aberration amounts similar to the Equation 13. Hence, the controller 80 calculates ΔG(n)z to AG(n)ωy through an optimization calculation which can minimize an absolute value of the Equation 13 relative to the Zernike term for evaluation (or the RMS value led from a plurality of Zernike terms). The calculated value is a drive instruction amount to the n-th drive mechanism. Although the Equation 13 assumes five drive elements for the N optical elements, the Equation 13 may be applied to drive shafts of the actual drive elements. S(k)i is an aberration sensitivity other than the positional fluctuation of the optical element, and an aberration sensitivity to the position of the substrate stage 40, the position of the original stage 20, and the wavelength. M is the number of parameters of the optical element other than the positional fluctuation. ΔT is a variation amount. Therefore, the memory 82 stores an aberration sensitivity table that expresses the positional fluctuation for each axis of the final optical element 34 or the other optical element 36.

Next, the controller 80 determines drive amounts of a plurality of optical elements 36 so as to cancel the aberration variation amount. In the determination, the memory 82 holds a table showing a relationship between the aberration variation amount and the drive amount, and the controller 80 refers to the memory 82. Next, the controller 80 controls the second movement unit 65 based on the determined drive amount, and moves the second holder 37. Alternatively, the memory 82 may hold the table showing a relationship between the variation amount of the final optical element 34 and one or more drive amounts of a plurality of optical elements 36. In this case, the controller 80 refers to the memory 82 and obtains one or more drive amounts of a plurality of optical elements 36 after the controller 80 obtains the movement amount of the final optical element 34.

A description will now be given of use of the first movement unit 61 and the position detector 72. When the position detector 72 is used, the prediction Equations 1-6 are unnecessary. In this case, the controller 80 can recognize the variation amount of the final optical element 34 when the position of the final optical element 34 fluctuates in the Z direction due to any disturbances that are not limited to the pressure of the liquid L, such as a vibration of the floor. Therefore, so as to cancel it, the controller 80 controls the first movement unit 61 and moves the final optical element 34 in a direction reverse to the fluctuation direction by the fluctuation amount.

A description will now be given of use of the second movement unit 65 and the position detector 72. The controller 80 operates an aberration amount that occurs as a result of that the final optical element 34 moves, based on the detection result of the position detector 72 and the Equations 12-13. Next, the controller 80 determines one or more drive amounts of a plurality of optical elements 36 so as to cancel out the aberration amount. Next, the controller 80 controls the second movement unit 65 and moves the second holder 37 based on the determined drive amount. Alternatively, the memory 82 may hold the table showing a relationship between the variation amount of the final optical element 34 and the drive amount of the optical element 36. In this case, the controller 80 refers to the memory 82 and obtains a drive amount of each optical element 36 after the controller 80 obtains the position variation amount of the final optical element 34.

A conventionally known feedback control detects a positional fluctuation of the correcting optical element that is provided to the projection optical system 30 and configured to correct the distortion, and moves the connecting optical element in the Z direction. In this case, the positional detection object is the correcting optical element, rather than the final optical element 34 unlike this embodiment. On the contrary, this prior art cannot correct the deterioration of the imaging characteristic caused by the positional fluctuation of the final optical element 34 due to the pressure change of the liquid L, because it does not provide the positional correction even when the position of the final optical element 34 fluctuates in the Z direction unless the position of the correcting optical element fluctuates in the Z direction.

In exposure, the exposure light that has transmitted the original M enters the projection optical system 30, and the projection optical system 30 projects an image of the pattern of the original M onto the substrate W. Since the liquid L has a refractive index higher than that of air, the resolution improves in comparison with use of air. Since the positional fluctuation of the final optical element 34 caused by the pressure change of the liquid L is corrected, the exposure apparatus can maintain a high imaging performance.

A manufacturing method of a device (such as a semiconductor integrated circuit device and a liquid crystal display device) includes the step of exposing a photosensitive agent applied substrate (such as a wafer and a glass plate) by utilizing the exposure apparatus, the developing step, and another known step.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-264902, filed Oct. 14, 2008, which is hereby incorporated by reference herein in its entirety.

What is claimed is:

1. An exposure apparatus configured to expose a substrate via a liquid filled in a space between the substrate and a final optical element in a projection optical system which is closest to the substrate, the exposure apparatus comprising:
a pressure detector configured to detect a pressure of the liquid;
a holder configured to hold the final optical element;
a movement unit configured to move the holder; and
a controller configured to control the movement unit and move the holder based on a detection result of the pressure detector so as to reduce an aberration of the projection optical system.

2. An exposure apparatus according to claim 1, wherein the movement unit moves the holder in at least one of an optical axis direction of the projection optical system, a direction orthogonal to the optical axis direction of the projection optical system, and a direction of a rotational axis that is set to the direction orthogonal to the optical axis direction of the projection optical system.

3. An exposure apparatus configured to expose a substrate via a liquid filled in a space between the substrate and a final optical element in a projection optical system which is closest to the substrate, the exposure apparatus comprising:
a pressure detector configured to detect a pressure of the liquid;
a holder configured to hold an optical element in the projection optical system other than the final optical element;
a movement unit configured to move the holder; and
a controller configured to control the movement unit and move the holder based on a detection result of the pressure detector so as to reduce an aberration of the projection optical system.

4. An exposure apparatus configured to expose a substrate via a liquid filled in a space between the substrate and a final optical element in a projection optical system which is closest to the substrate, the exposure apparatus comprising:
a position detector configured to detect a position of the final optical element in the projection optical system;
a holder configured to hold the final optical element;
a movement unit configured to move the holder; and
a controller configured to control the movement unit and move the holder based on a detection result of the position detector so as to reduce an aberration of the projection optical system.

5. An exposure apparatus configured to expose a substrate via a liquid filled in a space between the substrate and a final optical element in a projection optical system which is closest to the substrate, the exposure apparatus comprising:
a position detector configured to detect a position of the final optical element in the projection optical system;
a holder configured to hold an optical element in the projection optical system other than the final optical element;
a movement unit configured to move the holder; and
a controller configured to control the movement unit and move the holder based on a detection result of the position detector so as to reduce an aberration of the projection optical system.

6. A device manufacturing method comprising:
exposing a substrate using an exposure apparatus configured to expose a substrate via a liquid filled in a space between the substrate and a final optical element in a projection optical system which is closest to the substrate; and
developing the substrate that has been exposed,
wherein the exposure apparatus includes:
a pressure detector configured to detect a pressure of the liquid;
a holder configured to hold the final optical element;
a movement unit configured to move the holder; and
a controller configured to control the movement unit and move the holder based on a detection result of the pressure detector so as to reduce an aberration of the projection optical system.
